(19) United States
(12) Patent Application Publication
(10) Pub. No.: US 2025/0096498 A1
(43) Pub. Date: Mar. 20, 2025

(54) ELECTRICAL CONNECTOR AND USB TYPE-C CONNECTOR

(71) Applicant: All Best Elec tronic Technology Co., Ltd, Suzhou (CN)

(72) Inventors: Yulong MAO, Suzhou (CN); Bingbo HU, Suzhou (CN)

(21) Appl. No.: 18/889,805

(22) Filed: Sep. 19, 2024

(30) Foreign Application Priority Data
Sep. 20, 2023 (CN) 202311213811.5

(51) Int. Cl. H01R 13/405; H01R 12/70

(52) U.S. Cl. CPC H01R 13/405; H01R 12/707

(57) ABSTRACT

The present invention provides an electrical connector comprising an insulative housing and a plurality of contacts. The insulative housing has a mating tongue protruding forwardly, the mating tongue has an upper surface and a lower surface oppositely arranged along its thickness direction. The contacts are arranged in rows along a transverse direction, each contact has at least one contacting portion. The contacts comprise a pair of grounding contacts disposed on both sides in the transverse direction, each grounding contact is integrally formed with a lateral protruding portion extending outwardly along the transverse direction towards an outer side of the mating tongue, and a pair of contacting portions opposite to each other, the pair of contacting portions of each grounding contact comprises a first contacting portion exposed on the upper surface and a second contacting portion exposed on the lower surface.

### TECHNICAL FIELD

The present application relates to an electrical connector and a USB Type-C connector.

### BACKGROUND

With the rapid development of science and technology in the electronics industry, electronic products are trending towards increasingly lighter, thinner, and smaller designs. This trend demands increasingly smaller component sizes for electronic products, with the connector industry being at the forefront of this challenge.

The requirement for smaller dimensions in the new generation of USB Type-C connectors has led to higher demands on mechanical performance and increased difficulty in product design. To cater to thinner and more slender devices while ensuring product structural reliability, major manufacturers have introduced corresponding structural designs.

An existing USB Type-C electrical connector comprises a shell and a terminal module defined in the shell. The terminal module has a plastic housing, upper and lower rows of contacts retained in the plastic housing, and a middle plate located between the upper and lower rows of contacts. One of the functions of the middle plate is that it has a pair of locking portions protruding outwardly in a lateral direction, which enhances the strength of a locking area between the plastic housing and a complementary connector when the USB Type-C electrical connector mated with the complementary connector. However, due to the separate arrangement of the upper and lower rows of contacts and the middle plate, the structure of the entire electrical connector is relatively complex, and the manufacturing process is also quite complicated.

In view of this, it is necessary to improve the existing electrical connector to solve the above problems.

### SUMMARY

The object of the present application is to provide an electrical connector that is simple to manufacture and whose structural strength can be guaranteed.

In order to solve the technical problem, the present application provides an electrical connector comprising an insulative housing and a plurality of contacts retained in the insulative housing. The insulative housing has a mating tongue protruding forwardly, the mating tongue has an upper surface and a lower surface oppositely arranged along its thickness direction. The contacts are arranged in rows along a transverse direction of the insulative housing, each contact has at least one contacting portion exposed on the upper surface and the lower surface of the mating tongue. The contacts comprise a pair of grounding contacts disposed on both sides in the transverse direction, each grounding contact is integrally formed with a lateral protruding portion extending outwardly along the transverse direction towards an outer side of the mating tongue, and a pair of contacting portions opposite to each other, the pair of contacting portions of each grounding contact comprises a first contacting portion exposed on the upper surface of the mating tongue and a second contacting portion exposed on the lower surface of the mating tongue.

In order to solve the technical problem, the present application further provides a USB Type-C connector comprising an insulative housing and a plurality of contacts retained in the insulative housing. The contacts comprise two grounding contacts located on both sides. Each grounding contact is integrally formed with a contacting arm and a lateral protruding portion protruding outwardly from the contacting arm along a transverse direction of the insulative housing, the lateral protruding portion defines a locking portion.

Advantageous effects of the present application: The electrical connector of the present application integrally forms contacting portions and a lateral protruding portion on each grounding contact. This ensures the structural strength of the mating tongue of the insulative housing and its durability during insertion and removal, while simplifying the overall structure of the electrical connector. It eliminates the manufacturing and installation processes of the traditional middle plate, making production more convenient and cost-effective.

### BRIEF DESCRIPTION OF THE DRAWINGS

FIG. 1 is a perspective assembly view of a first embodiment of the electrical connector of the present application;

FIG. 2 is a view from another angle of the electrical connector shown in FIG. 1;

FIG. 3 is an exploded perspective view of the electrical connector shown in FIG. 1;

FIG. 4 is a perspective view of the contacts in the electrical connector shown in FIG. 1;

FIG. 5 is an exploded perspective view of the contacts shown in FIG. 4;

FIG. 6 is a top view of the contacts shown in FIG. 4;

FIG. 7 is a perspective view of a modified embodiment of the contacts shown in FIG. 4;

FIG. 8 is a perspective view of the contacts in a second embodiment of the electrical connector of the present application; and

FIG. 9 is a perspective view of the contacts in a third embodiment of the electrical connector of the present application.

### DETAILED DESCRIPTION

The following will provide a detailed description of the present application in conjunction with the embodiments shown in the accompanying drawings. However, these embodiments do not limit the present application, and any structural, methodological, or functional transformations made by those skilled in the art based on these embodiments are included within the scope of protection of the present application.

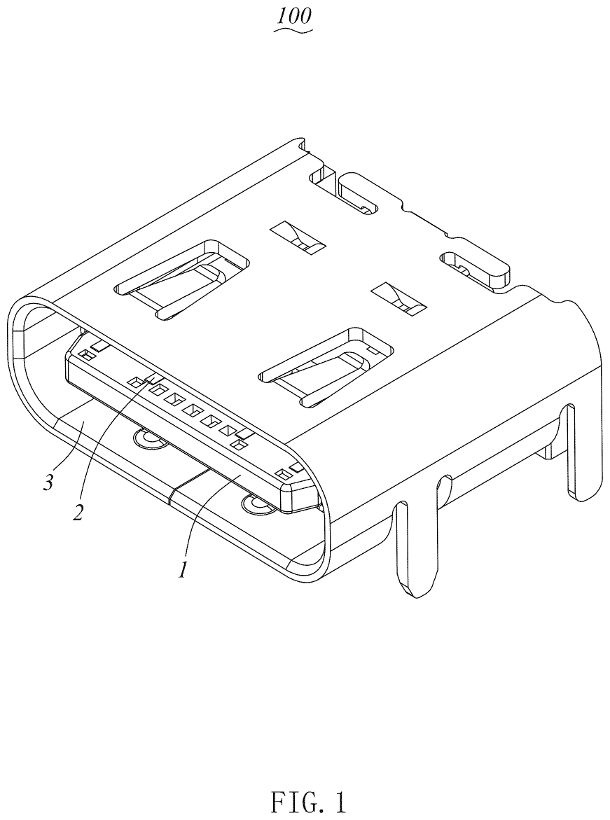

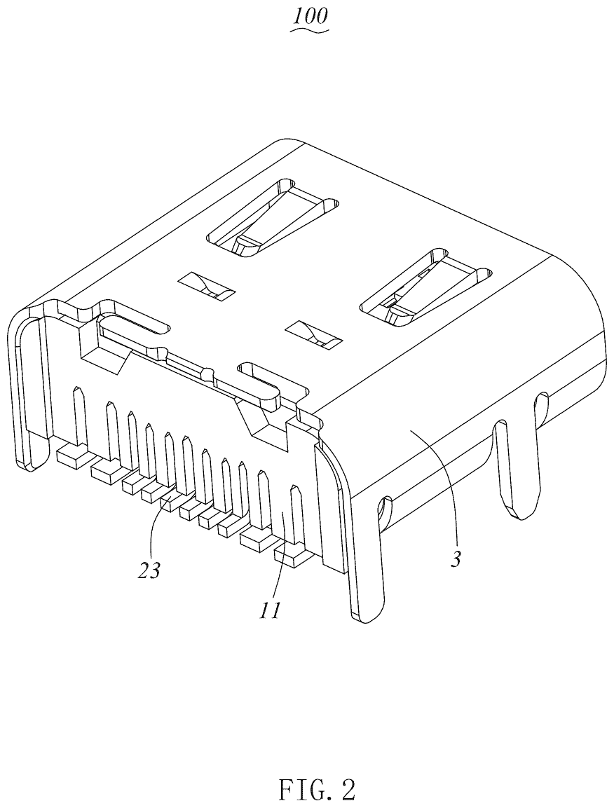

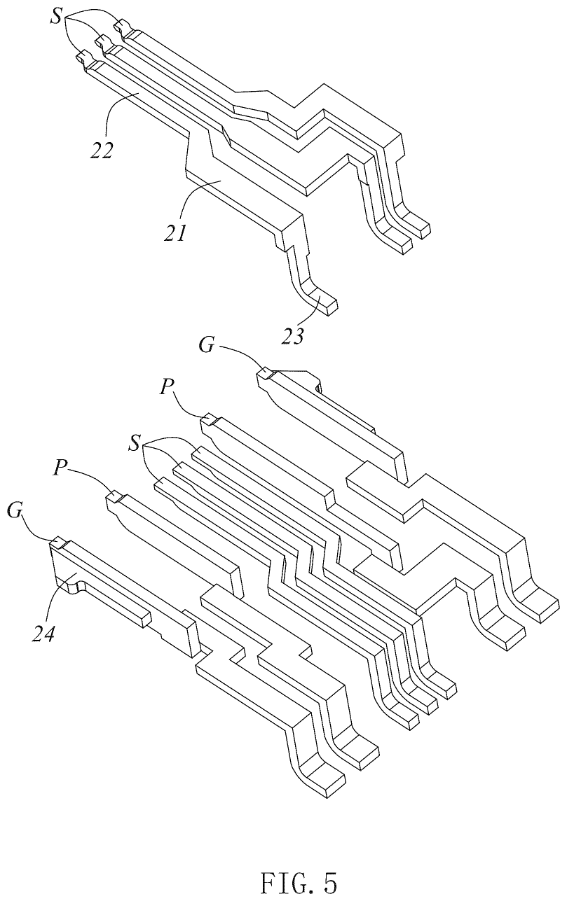

Please refer to FIGS. 1 to 7, which show a first embodiment of the electrical connector 100 of the present application. In this application, the electrical connector 100 is mounted on an external circuit board (not shown) and comprises a plurality of contacts 2 and an insulative housing 1 enclosing on the contacts 2.

For the description, when introducing the electrical connector 100 below, a mating end of the electrical connector 100 will be referred to as a front end, and an opposite end as a rear end. That is, a front-and-rear direction is a mating direction of the electrical connector 100 with a complementary connector (not shown). At the same time, one direction perpendicular to the front-and-rear direction is defined as a transverse direction, and another direction perpendicular to the front-and-rear direction is defined as a height direction (also referred to as an upper-and-lower direction).

Please refer to FIGS. 1 to 3, in this application, the insulative housing 1 is a one-piece structure, that is, it is formed by a single injection molding process. The contacts 2 are embedded in the insulative housing 1. The insulative housing 1 has a base portion 11 and a mating tongue 12 extending forward from the base portion 11. The mating tongue 12 has two opposite surfaces (i.e., upper and lower surfaces) along the height direction.

Additionally, in this embodiment, the insulative housing 1 further has a middle portion 13 located between the base portion 11 and the mating tongue portion 12.

The contacts 2 have a plurality of contacting portions 221 exposed on the aforementioned two surfaces of the mating tongue 12 to form an electrical connection with the complementary connector. Among these, the contacting portions 221 located on the upper surface of the mating tongue 12 are referred to as first contacting portions 2211 in the following text, and the contacting portions 221 located on the lower surface of the mating tongue 12 are referred to as second contacting portions 2213 in this application. In this embodiment, the electrical connector 100 is a USB Type-C connector. On the upper and lower surfaces of the mating tongue 12, the first contacting portions 2211 and the second contacting portions 2213 have the same signal transmission types as the contacts in corresponding positions in a standard USB Type-C electrical connector, and they are arranged in reverse order on the upper and lower surfaces of the mating tongue 12.

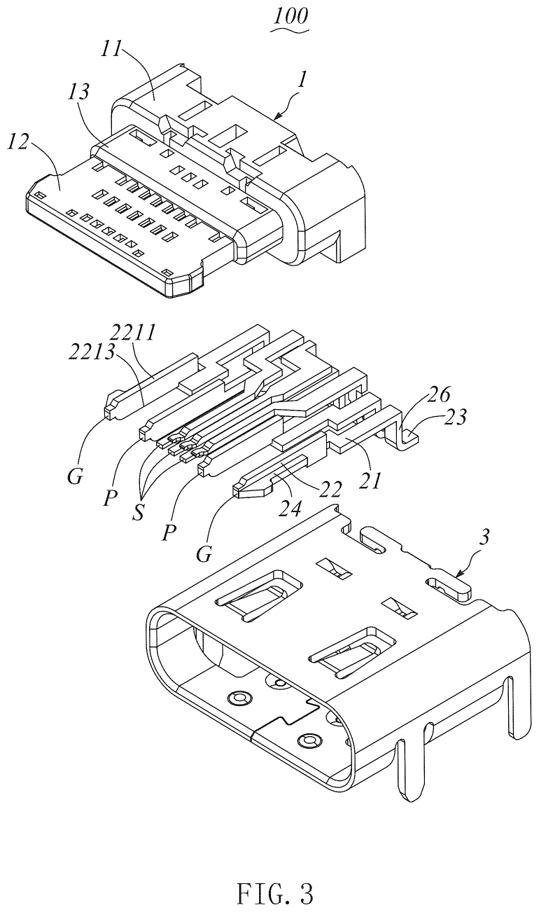

Please refer to FIGS. 3 to 6, each contact 2 has a retaining portion 21, a contacting arm 22 located at a front side of the retaining portion 21, and a soldering tail 23 located at a rear side of the retaining portion 21. In this embodiment, the soldering tails 23 of the contacts 2 all extend horizontally and backward to form surface mount type soldering feet, and they are arranged in a row along the transverse direction.

The contacting portion 221 is a part of the contacting arm 22. The contacting arm 22 of each contact 2 has at least one contacting portion 221. For example, it can have only one of the first contacting portion 2211 and the second contacting portion 2213, or it can have both the first contacting portion 2211 and the second contacting portion 2213.

In this application, the contacts 2 comprise a pair of grounding contacts G disposed on both outer sides in the transverse direction, and other contacts located between the pair of grounding contacts G. Each grounding contact G has a lateral protruding portion 24 integrally protruding outward along the transverse direction, and the first contacting portion 2211 and the second contacting portion 2213 oppositely arranged on upper and lower sides of the contacting arm 22 of the grounding contact G along a thickness direction of the mating tongue 12. Thus, by simultaneously forming the lateral protruding portion 24 and two contacting portions 221 on a single grounding contact G, and utilizing the lateral protruding portion 24 to lock with the complementary connector and/or ensure a structural strength of the mating tongue 12 of the insulative housing 1, this not only eliminates the need for a separate middle plate defined in a traditional electrical connector, but also simplifies the structure and manufacturing process of two grounding contacts corresponding to each other in the upper-and-lower direction.

In this embodiment, the contacting arm 22 of the grounding contact G is of a plate-like structure extending along the thickness direction of the mating tongue 12. Thus, the thickness direction of the mating tongue 12 can also be understood as the height direction of the contacting arm 22. The upper and lower surfaces of the contacting arm 22 of the grounding contact G form its first contacting portion 2211 and second contacting portion 2213, and the lateral protruding portion 24 protrudes outwardly from a lateral side of the contacting arm 22.

To facilitate the overall molding and positioning of the contacts 2, in this embodiment, the retaining portions 21 are arranged parallel to a horizontal plane or the mating tongue 12, and the contacting arm 22 of each grounding contact G is formed by bending from the retaining portion 21 and is arranged perpendicular to the horizontal plane.

Furthermore, the lateral protruding portion 24 is formed by drawing or tearing from the contacting arm 22 of the corresponding grounding contact G. Preferably, in this embodiment, the lateral protruding portion 24 is formed by drawing, which can harden the material of the metal sheet at this part, thereby enhancing the durability of the lateral protruding portion 24 during insertion and removal.

The contacting arms 22 are embedded in the mating tongue 12 with the contacting portions 221 exposed on both the upper and lower surfaces of the mating tongue 12. The lateral protruding portion 24 is at least partially embedded in the mating tongue 12 to ensure the structural strength of the mating tongue 12, and enhance the durability of the electrical connector 100 during insertion and removal.

Specifically, the lateral protruding portion 24 comprises a protruding bar 241 and a locking portion 242 located at a front side of the protruding bar 241. The protruding bar 241 is embedded in the mating tongue 12, the locking portion 242 is more outwards than the protruding bar 241 and is configured to match a shape of a front end of the mating tongue 12. Furthermore, a rear end of the protruding bar 241 is located at a front side of a front end of the retaining portion 21 of the grounding contact G.

In the height direction, the lateral protruding portion 24 is in a height range of the contacting arm 22 and is positioned in the middle between the first contacting portion 2211 and the second contacting portion 2213, thereby ensuring the structural strength of the mating tongue 12 via the lateral protruding portion 24.

The retaining portion 21 of each grounding contact G comprises a first retaining section 211 and a second retaining section 212 interconnected with each other. The first retaining section 211 and the second retaining section 212 are offset in the transverse direction. The soldering tail 23 extends rearward from the first retaining section 211 out of the insulative housing 1, and the contacting arm 22 is connected to a side of the second retaining section 212 that is farther from the adjacent power contact P in the transverse direction.

The first retaining section 211 is connected with one side of the second retaining section 212 in the transverse direction, causing the first retaining section 211 and the second retaining section 212 to be arranged in an offset manner, and the first retaining section 211 is located on an outer side of the second retaining section 212 in the transverse direction.

Each contact 2 further comprises a head portion 25 located at a front side of the contacting arm 22. In this embodiment, the lateral protruding portion 24 extends forward to a lateral side of the head portion 25 of the grounding contact G, and a front end face of the lateral protruding portion 24 is located behind a front end face of the head portion 25 of the grounding contact G.

Additionally, each contact 2 further has a connecting portion 26 that connects the retaining portion 21 and the soldering tail 23. The connecting portion 26 is in an upright state, and the connecting portions 26 of the contacts 2 are aligned in the transverse direction for easy positioning and fixation, while further arranging the soldering tails 23 of the contacts 2 in a row to facilitate subsequent soldering operations.

Of course, in other embodiments, the soldering tails 23 can also be formed by extending vertically downward directly from the retaining portion 21, thus forming through-hole type solder feet.

In this embodiment, the electrical connector 100 further comprises a pair of power contacts P disposed between the pair of grounding contacts G in the transverse direction. Each power contact P is also integrally formed with one first contacting portion 2211 and one second contacting portion 2213 opposite to each other. Similarly, the contacting arm 22 of the power contact P is also of a plate-like structure extending along the thickness direction of the mating tongue 12. Thus, the thickness direction of the mating tongue 12 can also be understood as the height direction of the contacting arm 22 of the power contact P. Consequently, the upper and lower surfaces of the contacting arm 22 of the power contact P form its first contacting portion 2211 and second contacting portion 2213.

The retaining portions 21 of the grounding contact G and the power contact P are completely offset, meaning there is no overlap between the retaining portion 21 of the grounding contact G and the retaining portion 21 of the power contact P in the thickness direction of the mating tongue 12.

In this embodiment, the power contacts P and the grounding contacts G are formed from a same metal sheet.

The electrical connector 100 in this embodiment further has six signal contacts S arranged in two rows. Three signal contacts S in one row, the grounding contacts G and the power contacts P are formed from one same metal sheet, while three signal contacts S in the other row are formed from another metal sheet. The three signal contacts S in each row include a CC (Configuration Channel) contact, a D+ (designates the USB 2.0 positive) contact, and a D− (designates the USB 2.0 negative) contact arranged sequentially in the transverse direction, where the D+ and D− contacts are mainly used for transmitting USB 2.0 signals. These signal contacts S each have one contacting portion 221, and the arrangement of these contacting portions 221 on the upper and lower surfaces of the mating tongue 12 also conforms to the arrangement rules of standard USB Type-C connectors.

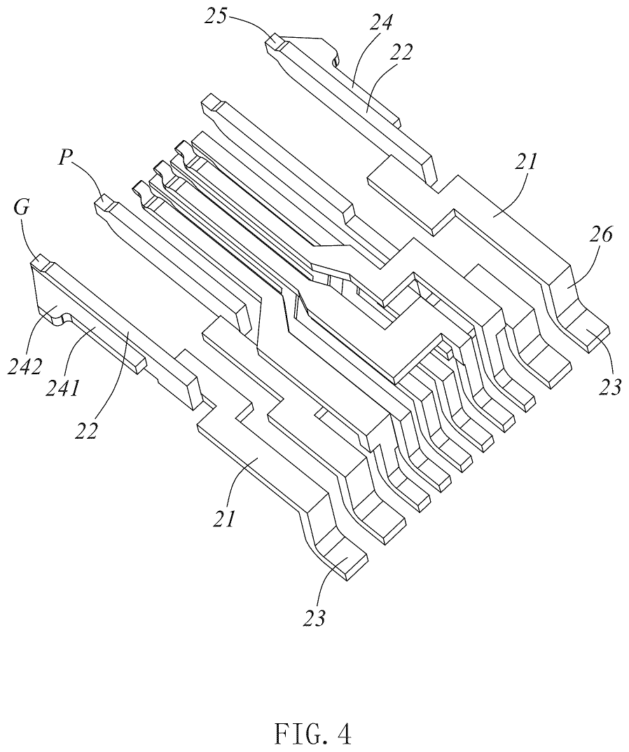

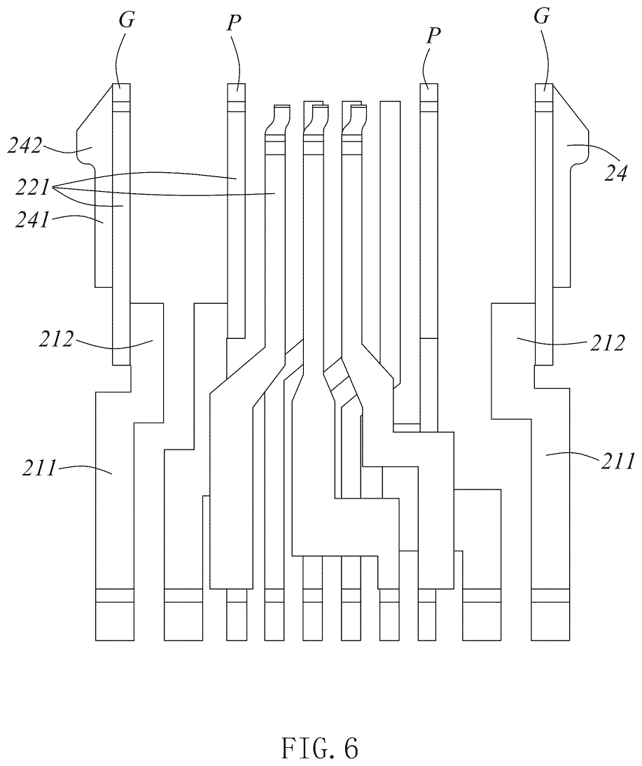

As can be seen from FIGS. 4 and 6, furthermore, in this embodiment, the contacting arms 22 of the contacts 2 in a same row are spaced apart from each other along the transverse direction of the insulative housing 1, the retaining portions 21 of the contacts 2 in a same row are also spaced apart from each other along the transverse direction of the insulative housing 1. In different rows of contacts 2 with vertically corresponding contacting portions 221, their retaining portions 21 do not overlap at least in part, and the head portions connected to the front ends of the contacting portions 221 do not overlap at least in part. This facilitates better positioning of different parts of the contacts 2 in the mold, thereby preventing deformation or displacement of the contacts due to impact of injection molding liquid.

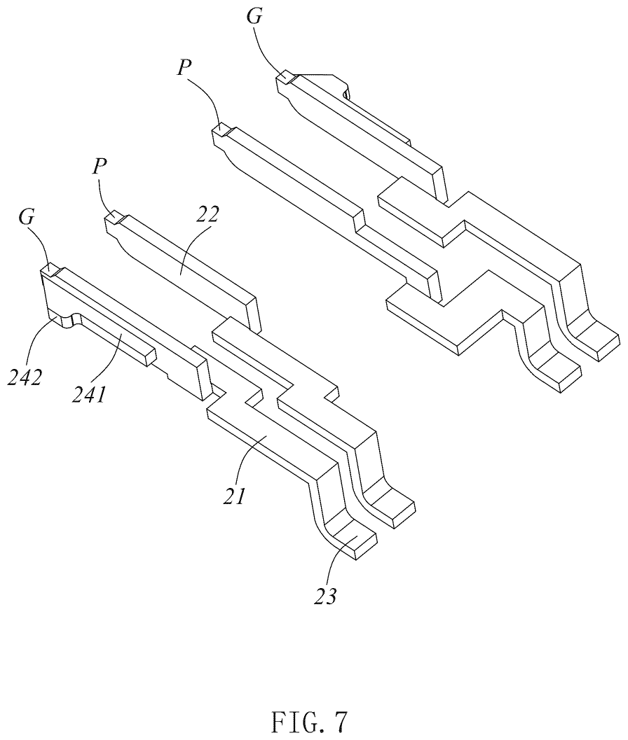

Additionally, FIG. 7 shows a modified embodiment of the electrical connector described in the first embodiment. In this modified embodiment, the electrical connector only has grounding contacts G and power contacts P, without the aforementioned signal contacts S. In this case, all contacts 2 can be formed from a single metal sheet. Of course, in other embodiments, the electrical connector 100 can also be set with one or three signal contacts in the same row according to usage requirements, in this case, the contacts 2 can still be formed from a single metal sheet.

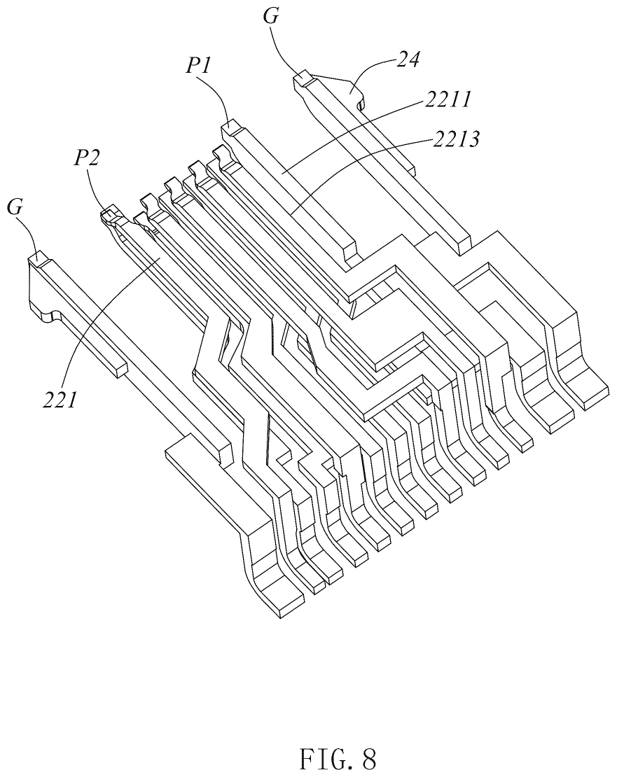

Please refer to FIG. 8, which shows the contacts 2 in the second embodiment of the electrical connector of the present application. The basic structure and assembly relationship of the electrical connector in this embodiment are essentially same as in the first embodiment, with the only difference being in the arrangement of the power contacts P. In this embodiment, the power contacts comprise a first power contact P1 and a pair of second power contacts P2 located between the grounding contacts. The first power contact P1 has a same structural configuration as the power contact P in the first embodiment, that is, it has a first contacting portion 2211 and a second contacting portion 2213 oppositely arranged on its two sides in the height direction. Each second power contact P2 has only one contacting portion 221, and the contacting portions 221 of the pair of second power contacts P2 are oppositely arranged in the height direction. In other words, in the second embodiment, compared to the first embodiment, one of the power contacts P is replaced by a pair of second power contacts P2 oppositely arranged.

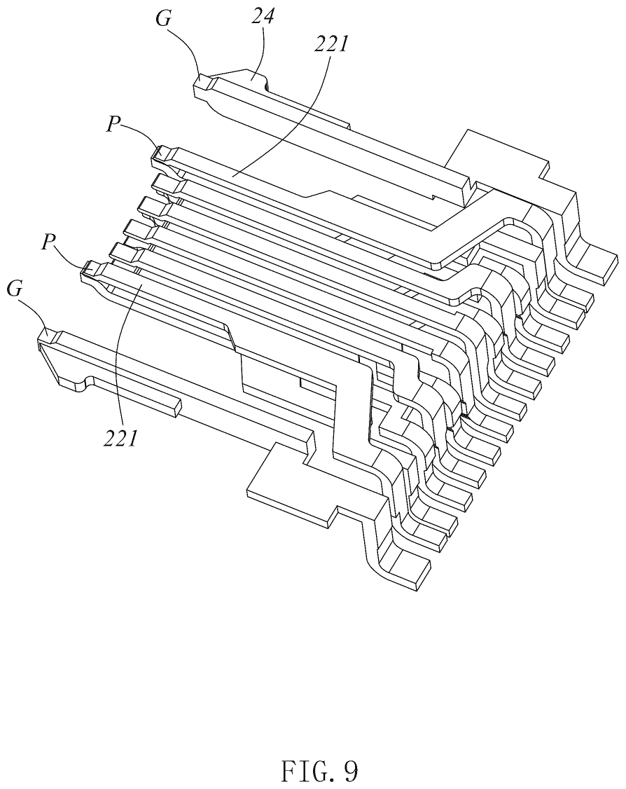

Please refer to FIG. 9, which shows the contacts 2 in a third embodiment of the electrical connector of the present application. The basic structure and assembly relationship of the electrical connector in this embodiment are essentially same as in the first embodiment, with the only difference also being in the arrangement of the power contacts P. The following will explain in detail: In this embodiment, the power contacts P comprise two independently arranged pairs, each power contact P has only one contacting portion 221, and the contacting portions 221 of each pair of power contacts P are oppositely arranged in the height direction.

In the preferred embodiment of the present application, in the preparation process of the electrical connector 100, the lateral protruding portion 24 needs to be formed on the metal sheet firstly by drawing or tearing, then cutting and stamping-bending to form various contacts, followed by injection molding the insulative housing 1 on the outer side of the contacts 2, and finally shielding a metal shell 3 on the outer side of the insulative housing 1, thus completing the production of the electrical connector 100. In this way, throughout the entire preparation process, only one injection molding process is required to form the insulative housing 1, and the lateral protruding portion 24 is integrally drawn or torn on the grounding contact G, thereby saving the manufacturing and installation processes of the middle plate, and making production convenient and cost-effective, while ensuring the structural strength of the mating tongue 12.

In summary, the electrical connector 100 of the present application forms the lateral protruding portion 24 integrally protruding outward on the side of each grounding contact G, thereby utilizing the lateral protruding portion 24 to ensure the structural strength of the mating tongue 12 and its durability during insertion and removal, thereby saving the manufacturing and installation processes of the traditional middle plate, making production convenient and cost-effective while ensuring the structural strength of the electrical connector 100.

The above embodiments are only used to illustrate the technical solution of the present application and are not limiting. Although the present application has been described in detail with reference to the preferred embodiments, those skilled in the art should understand that modifications or equivalent substitutions can be made to the technical solution of the present application without departing from the spirit and scope of the technical solution of the present application.

What is claimed is:

1. An electrical connector, comprising:
an insulative housing having a mating tongue protruding forwardly, the mating tongue having an upper surface and a lower surface oppositely arranged along its thickness direction; and
a plurality of contacts retained in the insulative housing, and arranged in rows along a transverse direction of the insulative housing; each contact having at least one contacting portion exposed on the upper surface and the lower surface of the mating tongue;
wherein the contacts comprise a pair of grounding contacts disposed on both sides in the transverse direction, each grounding contact is integrally formed with a lateral protruding portion extending outwardly along the transverse direction towards an outer side of the mating tongue, and a pair of contacting portions opposite to each other, the pair of contacting portions of each grounding contact comprises a first contacting portion exposed on the upper surface of the mating tongue and a second contacting portion exposed on the lower surface of the mating tongue.

2. The electrical connector according to claim 1, wherein each contact comprises a retaining portion, a contacting arm located at a front side of the retaining portion, and a soldering tail located at a rear side of the retaining portion, the contacting arm of the grounding contact is of a plate-like structure extending along the thickness direction of the mating tongue, and the first contacting portion and the second contacting portion of the grounding contact are formed on upper and lower surfaces of the contacting arm, respectively.

3. The electrical connector according to claim 2, wherein the lateral protruding portion protrudes outwardly from a lateral side of the contacting arm.

4. The electrical connector according to claim 2, wherein the retaining portion is arranged parallel to the mating tongue, and the contacting arm is formed by bending from the retaining portion.

5. The electrical connector according to claim 4, wherein the lateral protruding portion is formed by drawing or tearing from the contacting arm of the grounding contact.

6. The electrical connector according to claim 4, wherein the lateral protruding portion has a protruding bar connected to the retaining portion and a locking portion located at a front side of the protruding bar, the protruding bar is embedded in the mating tongue, the locking portion is more outwards than the protruding bar and is configured to match a shape of a front end of the mating tongue.

7. The electrical connector according to claim 3, wherein the lateral protruding portion is located between the first contacting portion and the second contacting portion along the thickness direction of the mating tongue.

8. The electrical connector according to claim 2, wherein the retaining portion of each grounding contact comprises a first retaining section and a second retaining section interconnected with each other, the first retaining section and the second retaining section are offset in the transverse direction, the soldering tail extends rearward from the first retaining section out of the insulative housing, and the contacting arm is connected to an outer side of the second retaining section.

9. The electrical connector according to claim 8, wherein the first retaining section is located on the outer side of the second retaining section in the transverse direction.

10. The electrical connector according to claim 2, wherein the contacts further comprise a pair of power contacts located on an inner side of the grounding contacts, the contacting arm of each power contact is also of a plate-like structure extending along the thickness direction of the mating tongue, each power contact has a pair of contacting portions, which are formed on the upper and lower surfaces of the contacting arm along the thickness direction of the mating tongue, respectively.

11. The electrical connector according to claim 2, wherein the contacts further comprise a first power contact and a pair of second power contacts located on an inner side of the grounding contacts, the first power contact is also of a plate-like structure extending along the thickness direction of the mating tongue and has two contacting portions oppositely arranged on its upper and lower sides along the thickness direction of the mating tongue, each second power contact has one contacting portion, and the contacting portions of the pair of second power contacts are oppositely arranged in the height direction.

12. The electrical connector according to claim 1, wherein the contacts further comprise two pairs of power contacts independently arranged, each power contact has one contacting portion, and the contacting portions of each pair of power contacts are oppositely arranged in the height direction.

13. A USB Type-C connector, comprising:
an insulative housing; and
a plurality of contacts retained in the insulative housing, the contacts comprising two grounding contacts located on both sides;
wherein each grounding contact is integrally formed with a contacting arm and a lateral protruding portion protruding outwardly from the contacting arm along a transverse direction of the insulative housing, the lateral protruding portion defines a locking portion.

14. The USB Type-C connector according to claim 13, wherein the insulative housing has a mating tongue protruding forwardly, the contacting arm is retained on the mating tongue and is of a plate-like structure extending along the thickness direction of the mating tongue, and the lateral protruding portion is formed by drawing or tearing from the contacting arm.

15. The USB Type-C connector according to claim 14, wherein upper and lower side surfaces of the contacting arm are exposed on upper and lower surfaces of the mating tongue respectively, and each one of the upper and lower side surfaces of the contacting arm forms a contacting portion, the lateral protruding portion is located between the two contacting portions of the grounding contact.

16. The USB Type-C connector according to claim 14, wherein the grounding contact further has a retaining portion connected to the contacting arm, the retaining portion is embedded in the insulative housing and parallel to the mating tongue, and the contacting arm is formed by bending from the retaining portion.

17. The electrical connector according to claim 16, wherein the retaining portion of each grounding contact comprises a first retaining section and a second retaining section interconnected with each other, the first retaining section and the second retaining section are offset in the transverse direction, the grounding contact further has a soldering tail extending rearward from the first retaining section out of the insulative housing, and the contacting arm is connected to an outer side of the second retaining section.

18. The USB Type-C connector according to claim 14, wherein the contacts further comprise two power contacts arranged between the two grounding contacts, and each power contact is adjacent to corresponding grounding contact, each power contact also has a contacting arm being of a plate-like structure extending along the thickness direction of the mating tongue, and a pair of contacting portions are formed at upper and lower ends of the contacting arm.

19. The USB Type-C connector according to claim 18, wherein each power contact further has a retaining portion connected to the contacting arm thereof, the retaining portion of the power contact is embedded in the insulative housing and parallel to the mating tongue, and the contacting arm of each power contact is formed by bending from the retaining portion.

20. The USB Type-C connector according to claim 14, wherein the contacts further comprise two pairs of independently arranged power contacts, each power contact has one contacting portion, and the contacting portions of each pair of power contacts are oppositely arranged on upper and lower surfaces of the mating tongue in a height direction.
